(19) United States
(12) Patent Application Publication
(10) Pub. No.: US 2005/0031357 A1
(43) Pub. Date: Feb. 10, 2005

(54) Controlling the extinction ratio in optical networks

(76) Inventors: Walter G. Soto, San Clemente, CA (US); Alexander I. Soto, San Diego, CA (US)

Correspondence Address: FISH & RICHARDSON P.C., 3300 DAIN RAUSCHER PLAZA, MINNEAPOLIS, MN, 55402, US

(21) Appl. No.: 10/886,021

(22) Filed: Jul. 6, 2004

Related U.S. Application Data
(60) Provisional application No. 60/485,077, filed on Jul. 3, 2003.

(51) Int. Cl. H04B 10/04

(52) U.S. Cl. 398/198

(57) ABSTRACT

A method and system for controlling extinction ratio in an optical network is disclosed. A first optical transceiver sends modulated light to a second optical transceiver and a digital measurement of a signal parameter reflecting the optical power levels of the received modulated light is taken. The modulated light sent by the first optical transceiver is adjusted in accordance with the digital measurement.

The application claims the benefit of U.S. Provisional Patent Application No. 60/485,077 filed Jul. 3, 2003.

### TECHNICAL FIELD

This invention relates to optical fiber networks.

### BACKGROUND

FIG. 1 shows optical power as a function of current for an optical transmitter over time. In general, digital optical communication systems transmit binary data using two levels of optical power, where the higher power level represents a binary 1 and the lower power level represents a binary 0. These two power levels can be represented as P₁ and P₀, where P₁>P₀ and the units of power are watts. The difference between P₁ and P₀ is an average power P_{avg}.

In optical transmitters, electrical current is converted to optical power and in optical receivers optical power is converted back to electrical current. The electrical currents I₁ and I₀ are proportional to the corresponding optical power levels and are controlled by the limit on modulation (I_{mod}) and bias (I_{bias}) currents of the transmitter's laser diode.

The ratio between the high level and the low level shown in the equation below is defined as the “extinction ratio” and is represented by the symbol rₑ.

$${r}_{e} = \frac{{I}_{1}}{{I}_{0}} = \frac{{P}_{1}}{{P}_{0}}$$

In an ideal transmitter, P₀ would be zero and thus rₑ would be infinite. In most practical optical transmitters, however, the laser must be biased so that P₀ is in the vicinity of the laser threshold, meaning that a finite amount of optical power is emitted at the low level and thus P₀>0. This increase in transmitted power due to non-ideal values of extinction ratio is called the “power penalty”. As the extinction ratio is degraded below its ideal value of infinity, the average power transmitted must be increased in order to maintain a constant Bit Error Rate (BER).

Seemingly small changes in extinction ratio can make a relatively large difference in power required to maintain a constant BER. The effect is especially acute for extinction ratios less than seven, where a change of one in extinction ratio value translates to an approximate 10% change in required average power. This additional required power is aptly termed the “power penalty”, as nothing is gained by this increase in power other than the unnecessary privilege of operating at a reduced extinction ratio.

As illustrated in FIG. 1, the slope of a laser diode's current to optical power transfer characteristics changes as a function of process, increasing temperature and age (e.g. curves T₁ and T₂). The slope variation can affect the extinction ratio, and therefore the BER, during the operational lifetime of an optical transmitter.

### SUMMARY

In one aspect, a method of controlling extinction ratio in an optical network configured for transmitting and receiving network data is provided. The extinction ratio can be controlled by providing a first optical transceiver configured for sending modulated light, a second optical transceiver configured for receiving modulated light, taking a digital measurement of at least one signal parameter reflecting the optical power levels of the received modulated light, and adjusting the modulated light sent by the first optical transceiver in accordance with the digital measurement.

Aspects of the invention can include one or more of the following features.

The measured signal parameter can include the high and low power levels of the received modulated light. The measured signal parameter can be the difference between high and low power levels of the received modulated light. The measured signal parameter can be the average power level of the received modulated light.

The digital measurement can be stored in memory. The average power levels of the received modulated light can be computed using the measured high and low power levels. The difference between measured high and low power levels can also be computed.

Data of a measured signal parameter can be transmitted from the second optical transceiver to the first optical transceiver. Network data can also be transmitted from the second optical transceiver to the first optical transceiver and the data of the digital measurement can be multiplexed into the network data.

A predetermined extinction ratio can be transmitted from the second optical transceiver to the first optical transceiver, or otherwise provided to the first optical transceiver. The predetermined signal parameter can be extinction ratio. The predetermined signal parameter can be average optical power. The predetermined signal parameter can be compared with the measured signal parameter.

Adjusting the modulated light sent by the first optical transceiver can include adjusting its extinction ratio. The average optical power of the modulated light sent by the fist optical transceiver can also be adjusted. Adjusting the extinction ratio of the sent modulated optical power can include adjusting the modulation current supplied to a laser diode in the first optical transceiver. The bias supplied to the laser diode can also be adjusted to adjust the average optical power of the sent modulated light.

Predetermined threshold values of bias and/or modulation current can be provided. The predetermined values of bias and/or modulation current can be compared with the adjusted bias and modulation current to determine whether the threshold values have been exceeded. If the threshold values have been exceeded, a visual indication can be provided.

Trace histories of the bias current adjustments and/or modulation current adjustment can be stored. The end of life of the laser diode can be predicted on the basis of the stored trace histories of the bias current adjustments and/or modulation current adjustments.

A visual indication of the time to end of life can be provided.

In another aspect, an optical network for transmitting and receiving network data is disclosed. The optical network can include a first optical transceiver configured for sending modulated light, a second optical transceiver configured for receiving modulated light, an optical fiber coupling the first optical transceiver to the second optical transceiver. The second optical transceiver can be configured to perform a digital measurement of at least one signal parameter reflecting optical power levels of the received modulated light. The first optical transceiver can be configured to adjust the modulated light sent by the first optical transceiver in accordance with the digital measurement.

Aspects of the invention may include one or more of the following features.

The signal parameter can include the high and low power levels, the difference between the high and low power levels and/or the average power level of the received modulated light.

The network can include a memory configured to store the digital measurement and a communication logic configured to compute the average power level and/or the difference between the high and low power levels of the received modulated light using the measured high and low power levels.

The second optical transceiver can be configured to transmit data of the measured signal parameter to the first optical transceiver. The data of the measured signal parameter can be multiplexed into the network data.

The second optical transceiver can be configured to transmit a predetermined signal parameter to the first optical transceiver. The predetermined signal parameter can include a predetermined extinction ratio and/or a predetermined average optical power. The fist optical transceiver can be configured to compare a predetermined signal parameter to the measured signal parameter.

The first optical transceiver can be configured to receive a predetermined signal parameter and compare the predetermined signal parameter to the measured signal parameter. The predetermined signal parameter can include a predetermined extinction ratio and/or a predetermined received average optical power.

Adjusting the modulated light sent by the first optical transceiver can include adjusting an extinction ratio and/or an average transmitted optical power of the sent modulated light. The first optical transceiver can include a laser diode and adjusting the extinction ratio of the sent modulated light can include adjusting the range of the modulation current supplied to the laser diode. The first optical transceiver can include a laser diode and adjusting the average transmitted optical power of the sent modulated light can include adjusting the bias current supplied to the laser diode.

The network can include a memory configured to store a predetermined threshold value of a range of a modulation current. The network can include a communication logic configured to compare the predetermined threshold value of a range of a modulation current to the adjusted modulation current supplied to a laser diode. If the adjusted range of modulation current exceeds the threshold value, a visual indication can be provided.

The network can include a memory configured to store a predetermined threshold value of bias current. The network can include a communication logic configured to compare the predetermined threshold value of bias current to the adjusted bias supplied to a laser diode. If the adjusted bias current exceeds the threshold value, a visual indication can be provided.

The network can include a memory configured for storing trace histories of the modulation and/or bias current adjustments. The network can include communication logic configured to predict the end of life of a first optical transceiver's laser diode on the basis of the trace histories of the modulation and/or bias current adjustments.

The network can include communication logic configured to provide a visual indication reflecting a predicted time to end of life.

Advantages of the invention can include one or more of following. Aspects of the invention enable the control of extinction ratio in optical fiber networks without the use of ancillary detectors such as photodiodes dedicated exclusively for extinction ratio monitoring. This allows extinction ratio to be controlled with fewer components than conventional systems. Moreover, aspects of the invention accurately control extinction ratio by using optical transceivers capable of accurately detecting high and low power levels in the data signal. Further, aspects of the invention provide for an efficient way to maintain an optical network over time as components reach their end of life.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows optical power as a function of current for an optical transmitter over time.

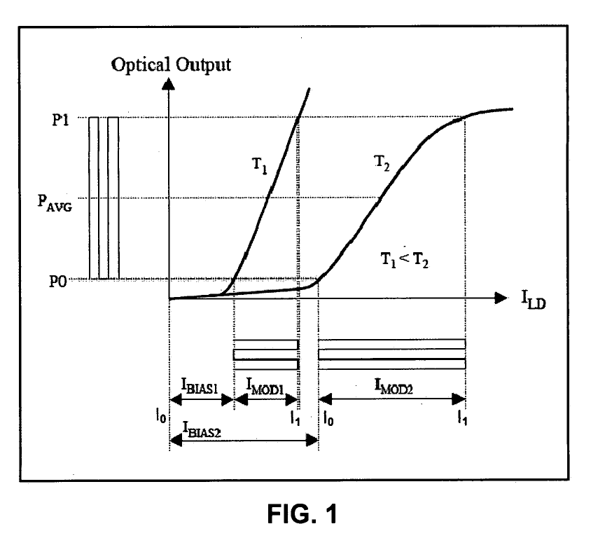

FIG. 2 shows an optical fiber network.

FIG. 3 shows a block diagram of a passive optical fiber network.

FIG. 4 is a flow diagram showing a method of controlling extinction ratio in an optical network.

Like reference symbols in the various drawings indicate like elements.

### DETAILED DESCRIPTION

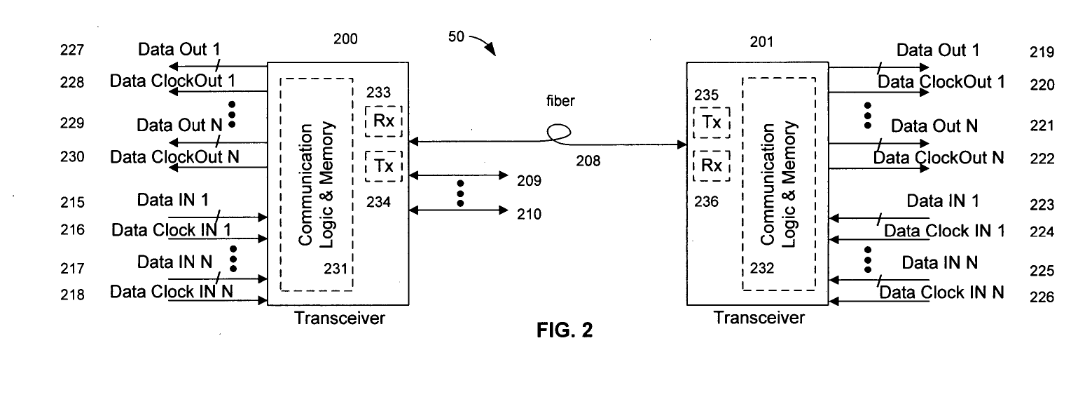

FIG. 2 shows a high-level fiber optic data network 50. The network includes a first transceiver 200 in communication with a second transceiver 201 via a fiber 208. The first transceiver 200 and the second transceiver 201 include transmitter circuitry (Tx) 234, 235 to convert electrical data input signals into modulated light signals for transmission over the fiber 208. In addition, the first transceiver 200 and the second transceiver 201 also include receiver circuitry (Rx) 233, 236 to convert optical signals received via the fiber 208 into electrical signals and to detect and recover encoded data and/or clock signals. First transceiver 200 and second transceiver 201 may contain a micro controller (not shown) and/or other communication logic and memory 231, 232 for network protocol operation. Although the illustrated and described implementations of the transceivers 200, 201 include communication logic and memory in a same package or device as the transmitter circuitry 234, 235 and receiver circuitry 233, 236, other transceiver configurations may also be used.

First transceiver 200 transmits/receives data to/from the second transceiver 201 in the form of modulated optical light signals via the optical fiber 208. The transmission mode of the data sent over the optical fiber 208 may be continuous, burst or both burst and continuous modes. Both transceivers 200, 201 may transmit a same wavelength (e.g., the light signals are polarized and the polarization of light transmitted from one of the transceivers is perpendicular to the polarization of the light transmitted by the other transceiver). Alternatively, a single wavelength can be used by both transceivers 200, 201 (e.g., the transmissions can be made in accordance with a time-division multiplexing scheme or similar protocol).

In another implementation, bi-directional wavelength-division multiplexing (WDM) may also be used. Bi-directional WDM is herein defined as any technique by which two optical signals having different wavelengths may be simultaneously transmitted bi-directionally with one wavelength used in each direction over a single fiber. In yet another implementation, bi-directional dense wavelength-division multiplexing (DWDM) may be used. Bi-directional DWDM is herein defined as any technique by which more than two optical signals having different wavelengths may be simultaneously transmitted bi-directionally with more than one wavelength used in each direction over a single fiber with each wavelength unique to a direction. For example, if wavelength division multiplexing is used, the first transceiver 200 may transmit data to the second transceiver 201 utilizing a first wavelength of modulated light conveyed via the fiber 208 and, similarly, the second transceiver 201 may transmit data via the same fiber 208 to the first transceiver 200 utilizing a second wavelength of modulated light conveyed via the same fiber 208. Because only a single fiber is used, this type of transmission system is commonly referred to as a bi-directional transmission system. Although the fiber optic network illustrated in FIG. 2 includes a first transceiver 200 in communication with a second transceiver 201 via a single fiber 208, other implementations of fiber optic networks, such as those having a first transceiver in communication with a plurality of transceivers via a plurality of fibers (not shown), may also be used.

Electrical data input signals (Data IN 1) 215, as well as any optional clock signal (Data Clock IN 1) 216, are routed to the transceiver 200 from an external data source (not shown) for processing by the communication logic and memory 231. Communication logic and memory 231 process the data and clock signals in accordance with an in-use network protocol. Communication logic and memory 231,232 provides management functions for received and transmitted data including queue management (e.g., independent link control) for each respective link, demultiplexing/multiplexing and other functions as described further below. The processed signals are transmitted by the transmitter circuitry 234. The resulting modulated light signals produced from the first transceiver's 200 transmitter 234 are then conveyed to the second transceiver 201 via the fiber 208. The second transceiver 201, in turn, receives the modulated light signals via the receiver circuitry 236, converts the light signals to electrical signals, processes the electrical signals using the communication logic and memory 232 (in accordance with an in-use network protocol) and, optionally, outputs the electrical data output signals (Data Out 1) 219, as well as any optional clock signals (Data Clock Out 1) 220.

Similarly, the second transceiver 201 receives electrical data input signals (Data IN 1) 223, as well as any optional clock signals (Data Clock IN) 224, from an external data source (not shown) for processing by the communication logic and memory 232 and transmission by the transmitter circuitry 235. The resulting modulated light signals produced from the second transceiver's 201 transmitter 235 are then conveyed to the first transceiver 200 using the optical fiber 208. The first transceiver 200, in turn, receives the modulated light signals via the receiver circuitry 233, converts the light signals to electrical signals, processes the electrical signals using the communication logic and memory 231 (in accordance with an in-use network protocol), and, optionally, outputs the electrical data output signals (Data Out 1) 227, as well as any optional clock signals (Data Clock Out 1) 228.

Fiber optic data network 50 may also include a plurality of electrical input and clock input signals, denoted herein as Data IN N 217/225 and Data Clock IN N 218/226, respectively, and a plurality of electrical output and clock output signals, denoted herein as Data Out N 229/221 and Data Clock Out N 230/222, respectively. The information provided by the plurality of electrical input signals may or may not be used by a given transceiver to transmit information via the fiber 208 and, likewise, the information received via the fiber 208 by a given transceiver may or may not be outputted by the plurality of electrical output signals. The plurality of electrical signals denoted above can be combined to form data plane or control plane bus(es) for input and output signals respectively. In some implementations, the plurality of electrical data input signals and electrical data output signals are used by logic devices or other devices located outside (not shown) a given transceiver to communicate with the transceiver's communication logic and memory 231, 132, transmit circuitry 234, 235, and/or receive circuitry 233,236.

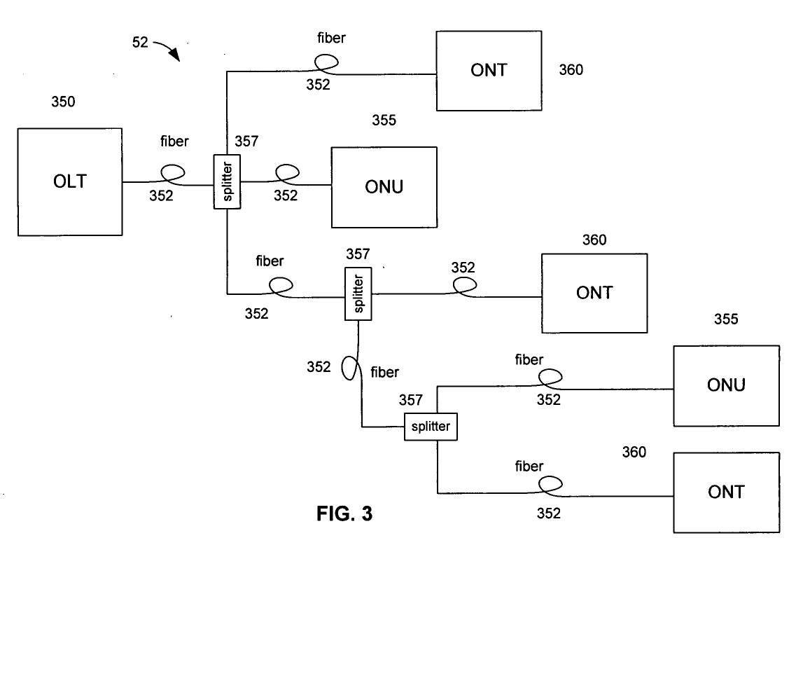

FIG. 3 illustrates an implementation of a passive optical network (PON) 52, where the functions described above associated with the first transceiver 200 and the second transceiver 201 of FIG. 2, are implemented in an optical line terminator (OLT) 350 and one ore more optical networking units (ONU) 355, and/or optical networking terminals (ONT) 360, respectively. PON(s) 52 may be configured in either a point-to-point network architecture, wherein one OLT 350 is connected to one ONT 360 or ONU 355, or a point-to-multipoint network architecture, wherein one OLT 350 is connected to a plurality of ONT(s) 360 and/or ONU(s) 355. In the implementation shown in FIG. 3, an OLT 350 is in communication with multiple ONTs/ONUs 360, 355 via a plurality of optical fibers 352. The fiber 352 coupling the OLT 350 to the PON 52 is also coupled to other fibers 352 connecting the ONTs/ONUs 360, 355 by one or more passive optical splitters 157. All of the optical elements between an OLT and ONTs/ONUs are often referred to as the Optical Distribution Network (ODN). Other alternate network configurations, including alternate implementations of point-to-point and point-to-multipoint networks are also possible.

A receiver RX 236 of a transceiver 201 receives optical data transmissions from another transceiver 200 in the form of modulated light. The receiver RX 236 is capable of digitally measuring the received optical power of the data transmissions. The digital measurements include the received optical power for the high and the low data transmission and/or the difference between the optical high and the optical low data transmissions. The Communication Logic & Memory 232 of transceiver 201 stores the digital measurement(s) for eventual transmission back to the transmitting transceiver 200. Additionally the Communication Logic & Memory 232 may compute and store, an average of the stored high, low and/or difference values for eventual transmission back to the transmitting transceiver 200. The Communication Logic & Memory 232 may also compute and store the difference between a desired value and the stored values for eventual transmission back to the transmitting transceiver 200. The Communication Logic & Memory 232 can include volatile and/or non-volatile memory, registers, buffers, or other circuitry for storing data. The transmission of the digital measurement(s) is accomplished by multiplexing a message containing the digital measurement(s) into the user data, management and/or control traffic of the network protocol in-use.

Various events can trigger the transceiver 201 to begin measuring and/or storing data about the extinction ratio and average received power of the received modulated light. For example, the transceiver 201 can perform the measurements automatically at predetermined intervals. The transceiver 201 can also receive a message to measure extinction ratio and/or average power from some other transceiver in the fiber optical network. This message can come from the transmitting transceiver 200, or from some upstream transceiver, for example, a transceiver that can transmit to transceiver 201.

Transmitting transceiver 200 may have prior knowledge of receiving transceiver's 201 desired received extinction ratio and desired received average optical power. Alternatively, receiving transceiver 201 may transmit its desired received extinction ratio and desired received average optical power with the digital measurement(s). Once transmitting transceiver 200 receives the digital measurement(s) and/or the any of the stored values described above, the extinction ratio and average transmitting optical power of transmitter Tx 234 may be adjusted. The adjustment of the average transmitting power is accomplished by changing the I_{bias} current to the laser diode contain in transmitter Tx 234 appropriately to match receive transceiver's 201 desired received optical power based on the digital measurement(s). The adjustment of the extinction ratio is accomplished by changing the range of the I_{mod} current to the laser diode contain in transmitter Tx 234 appropriately to match the receive transceiver's 201 desired received extinction ratio based on the digital measurement(s).

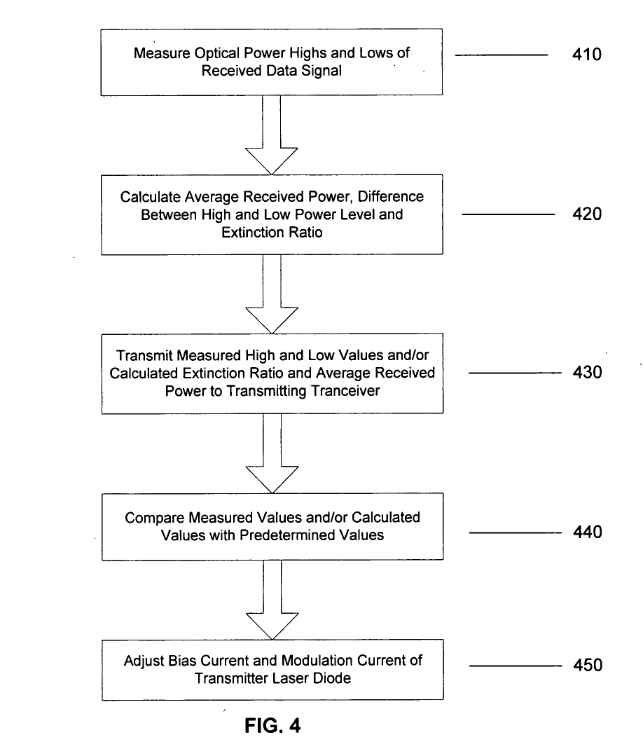

FIG. 4 is a flow chart diagram showing a method of controlling extinction ratio. First a receiving transceiver measures the optical power highs and lows of a received data signal 410. Next, the average received optical power, the difference between the high and low power level, and the extinction ratio are calculated 420. This information or a subset thereof is then transmitted through the network to the transmitting transceiver 430. The measured values and/or calculated values are then compared with predetermined values for extinction ratio and average transmitted power 440. The bias and modulation current of the laser diode in the transceiver's transmitter are then adjusted such that the average power and extinction ratio of the data signal received at the receiving transceiver match the predetermined values 450.

With a trace history of changes to a transceiver's extinction ratio and/or average transmitted power (e.g. I_{bias} and I_{mod} current changes) or with knowledge of present I_{bias} current value and range of I_{mod} current, a prediction can be made of a period of time before “end of life” of the transceiver's laser diode. The trace history may be stored at the transceiver, for example in the communication logic and memory, or at a network entity operating at an application layer in the protocol in-use according to the Open Systems Interconnection (OSI) 7 layer reference model (hereby included by reference). Alternatively, the transceiver may also have a predetermined thresholds for I_{bias} and I_{mod} currents to predict the “end of life” of its laser diode. Once the I_{bias} and I_{mod} currents pass or cross the thresholds the transceiver may give a visual indication of having reached the predetermined prediction period or period before “end of life”. In either cases, the transceiver may declare by means of a visual indication of having reached the period before “end of life” e.g., light an LED, change an LED's color or generate a message to a network entity operating at an OSI application layer via the protocol in-use resulting in a visible report. The comparing and declaration functions can be implemented in the communication logic.

Once a transceiver is not able to adjust its extinction ratio to meet a desired extinction ratio then the laser diode within the transceiver is declared to have reached its “end of life”. Alternatively declaring “end of life” may be triggered by detecting I_{bias} and I_{mod} currents passing or crossing a predetermined threshold wherein the laser diode consumers too much power to maintain a desired extinction ratio or average transmitted power. In either case, the transceiver may declare by means of a visual indication of having reached “end of life” e.g., light an LED, change an LED's color or generate a message to a network entity operating at an OSI application layer via the protocol in-use resulting in a visible report.

Although the invention has been described in terms of particular implementations, one of ordinary skill in the art, in light of this teaching, can generate additional implementations and modifications without departing from the spirit of or exceeding the scope of the claimed invention. Accordingly, it is to be understood that the drawings and descriptions herein are proffered by way of example to facilitate comprehension of the invention and should not be construed to limit the scope thereof. Accordingly, other embodiments are within the scope of the following claims.

1. A method of controlling extinction ratio in an optical network configured for transmitting and receiving network data, the method comprising the steps of
providing a first optical transceiver configured for sending modulated light,
providing a second optical transceiver configured for receiving modulated light,
taking a digital measurement of at least one signal parameter reflecting the optical power levels of the received modulated light, and
adjusting the modulated light sent by the first optical transceiver in accordance with the digital measurement.

2. The method of claim 1, wherein the signal parameter includes high and low power levels of the received modulated light.

3. The method of claim 1, wherein the signal parameter is a difference between high and low power levels of the received modulated light.

4. The method of claim 1, wherein the signal parameter is an average power level of the received modulated light.

5. The method of claim 1, further comprising the step of storing the digital measurement in memory.

6. The method of claim 2, further comprising the step of computing average power levels of the received modulated light using the measured high and low power levels.

7. The method of claim 2, further comprising the step of computing a difference between the measured high and low power levels.

8. The method of claim 1, further comprising the step of transmitting data of the measured signal parameter from the second optical transceiver to the first optical transceiver.

9. The method of claim 8, further comprising the steps of
providing network data transmitted from the second optical transceiver to the first optical transceiver,
and multiplexing data of the digital measurement into the network data.

10. The method of claim 8, further comprising the step of transmitting a predetermined signal parameter from the second optical transceiver to the first optical transceiver.

11. The method of claim 10, wherein the predetermined signal parameter is a predetermined received extinction ratio.

12. The method of claim 10, wherein the predetermined signal parameter is a predetermined received average optical power.

13. The method of claim 10, further comprising the step of comparing the predetermined signal parameter with the measured signal parameter.

14. The method of claim 8, further comprising the steps of providing a predetermined signal parameter to the first optical transceiver and comparing the predetermined signal parameter with the measured signal parameter.

15. The method of claim 14, wherein the predetermined signal parameter is a predetermined extinction ratio.

16. The method of claim 14, wherein the predetermined signal parameter is a predetermined received average optical power.

17. The method of claim 1, wherein adjusting the modulated light includes adjusting an extinction ratio of the sent modulated light.

18. The method of claim 1, wherein adjusting the modulated light includes adjusting an average transmitted optical power of the sent modulated light.

19. The method of claim 17, wherein adjusting the extinction ratio of the sent modulated light includes adjusting a range of the modulation current supplied to a laser diode in the first optical transceiver.

20. The method of claim 19 further comprising the steps of
providing a predetermined threshold value of a range of the modulation current supplied to the laser diode in the first optical transceiver,
determining whether a adjusted range of the modulation current supplied to the laser diode in the first optical transceiver exceeds the predetermined threshold value, and
if the adjusted range of the modulation current supplied to the laser diode in the first optical transceiver exceeds the predetermined threshold value, providing a visual indication.

21. The method of claim 19, further comprising the step of storing a trace history of the modulation current adjustments in memory.

22. The method of claim 21, further comprising the step of predicting an end of life the laser diode on the basis of the stored trace history of the modulation current adjustments.

23. The method of claim 22 further comprising the step of providing a visual indication reflecting a predicted time to an end of life of the laser diode.

24. The method of claim 18, wherein adjusting the average transmitting optical power of the sent modulated light includes adjusting a bias current supplied to a laser diode in the first optical transceiver.

25. The method of claim 24 further comprising the steps of
providing a predetermined threshold value of the bias current supplied to the laser diode in the first optical transceiver,
determining whether an adjusted bias current supplied to the laser diode in the first optical transceiver exceeds the predetermined threshold value, and
if the adjusted bias current supplied to the laser diode in the first optical transceiver exceeds the predetermined threshold value, triggering a visual indication.

26. The method of claim 24, further comprising the step of storing a trace history of the bias current adjustments in memory.

27. The method of claim 26, further comprising the step of predicting an end of life the laser diode on the basis of the stored trace history of the bias current adjustments.

28. The method of claim 27 further comprising the step of providing a visual indication reflecting a predicted time to the end of life of the laser diode.

29. An optical network for transmitting and receiving network data comprising:
a first optical transceiver configured for sending modulated light;
a second optical transceiver configured for receiving modulated light;
an optical fiber coupling the first optical transceiver to the second optical transceiver;
where the second optical transceiver is configured to perform a digital measurement of at least one signal parameter reflecting optical power levels of the received modulated light, and
where the first optical transceiver is configured to adjust the modulated light sent by the first optical transceiver in accordance with the digital measurement.

30. The optical network of claim 29, wherein the signal parameter includes high and low power levels of the received modulated light.

31. The optical network of claim 29, wherein the signal parameter is a difference between the high and low power levels of the received modulated light.

32. The optical network of claim 29, wherein the signal parameter is an average power level of the received modulated light.

33. The optical network of claim 29, further comprising memory configured to store the digital measurement.

34. The optical network of claim 30, further comprising communication logic configured to compute average power levels of the received modulated light using the measured high and low power levels.

35. The optical network of claim 30, further comprising communication logic configured to compute a difference between the high and low power levels.

36. The optical network of claim 29, wherein the second optical transceiver is configured to transmit data of the measured signal parameter to the first optical transceiver.

37. The optical network of claim 36, wherein the data of the measured signal parameter is multiplexed into the network data.

38. The optical network of claim 36, wherein the second optical transceiver is configured to transmit a predetermined signal parameter to the first optical transceiver.

39. The optical network of claim 38, wherein the predetermined signal parameter is a predetermined received extinction ratio.

40. The optical network of claim 38, wherein the predetermined signal parameter is a predetermined average optical power.

41. The optical network of claim 38, wherein the first optical transceiver is configured to compare the predetermined signal parameter to the measured signal parameter.

42. The optical network of claim 36, wherein the first optical transceiver is configured to receive a predetermined signal parameter and compare the predetermined signal parameter to the measured signal parameter.

43. The optical network of claim 42, wherein the predetermined signal parameter is a predetermined extinction ratio.

44. The optical network of claim 42, wherein the predetermined signal parameter is a predetermined received average optical power.

45. The optical network of claim 29, wherein adjusting the modulated light sent by the first optical transceiver includes adjusting an extinction ratio of the sent modulated light.

46. The optical network of claim 29, wherein adjusting the modulated light sent by the first optical transceiver includes adjusting an average transmitted optical power of the sent modulated light.

47. The optical network of claim 45, wherein the first optical transceiver includes a laser diode and wherein adjusting the extinction ratio of the sent modulated light includes adjusting a range of a modulation current supplied to the laser diode.

48. The optical network of claim 47 further comprising:
a memory configured to store a predetermined threshold value of a range of modulation current supplied to the laser diode,
a communication logic configured to determine whether an adjusted range of modulation current supplied to the laser diode has exceeded the threshold value, and
a communication logic configured to provide a visual indication if the adjusted range of modulation current supplied to the laser diode has exceeded the threshold value.

49. The optical network of claim 47, further comprising a memory configured to store a trace history of modulation current adjustments.

50. The optical network of claim 48, further comprising a communication logic configured to predict an end of life the laser diode on the basis of a stored trace history of modulation current adjustments.

51. The optical network of claim 50 wherein the communication logic is configured to provide a visual indication reflecting a predicted time to end of life of the laser diode.

52. The optical network of claim 46, wherein the first optical transceiver includes a laser diode and wherein adjusting the average transmitted optical power of the modulated light includes adjusting a bias current supplied to the laser diode.

53. The optical network of claim 52 further comprising:
a memory configured to store a predetermined threshold value of the bias current supplied to the laser diode,
a communication logic configured to determine whether the adjusted bias current supplied to the laser diode has exceeded the threshold value, and
a communication logic configured to provide a visual indication if the adjusted bias current supplied to the laser diode has exceeded the threshold value.

54. The optical network of claim 52, further comprising a memory configured to store a trace history of bias current adjustments.

55. The optical network of claim 54, further comprising a communication logic configured to predict an end of life the laser diode on a basis of the stored trace history of the bias current adjustments.

56. The optical network of claim 55 wherein the communication logic is configured to provide a visual indication reflecting a predicted time to end of life of the laser diode.
